(19) United States
(12) Patent Application Publication
(10) Pub. No.: US 2009/0113672 A1
(43) Pub. Date: May 7, 2009

(54) INTRINSICALLY-SAFE RAMP FOR USE BY RESCUE PERSONNEL

(76) Inventor: JERRY Alan IBEY, Whittier, CA (US)

Correspondence Address: RIOS INVENTIONS, 13337 SOUTH ST., # 177, CERRITOS, CA, 90703-7300, US

(21) Appl. No.: 11/936,239

(22) Filed: Nov. 7, 2007

(51) Int. Cl. E05F 5/00

(52) U.S. Cl. 16/404

(57) ABSTRACT

An intrinsically-safe ramp or door prop (10) characterized by a light-weight, transparent ramp having an acutely-angled frontal edge (20), at least one rotatable member or rocker-plate (14) pivotally-attached, for increasing its height, further comprising a kinetic-friction lock, and wireless interface control (28) between an adjacently-housed electronic circuit (16). The circuit (42) is replaceable and sealed and intrinsically-safe for deployment in potentially-flammable or ignitable environments. The electronic circuit further comprises a plurality of multi-colored lamps (24) that visually communicate tactically-significant color signals and bears circuitry (42) to extend battery life wherein lamps may continuously operate for multiple hours. The ramp further comprises attachment points (30) (31) to gang-together a multiplicity of identical ramps whereby fashioning one contiguous block (FIG. 6) of ramps. The block or ramps further being easily manipulated by a user wearing gloves and easily transportable within a utility pocket.

### BACKGROUND OF THE INVENTION

The invention relates to tools and hardware deployable by Firefighters and other Search and Rescue Personnel and more specifically to a ramp capable of securing a door in a fixed position where potentially-flammable or ignitable substances may be present and further serving to illuminate a doorway to mark its location for future evidence investigations, indicate egress pathways, and communicate tactically-significant, color-coded, visual signals to other rescuers.

There is a growing concern for the personal safety of Firefighters and other Rescue Personnel when entering buildings which may be compromised such that visibility may be impaired by smoke or darkness, and where potentially-flammable or ignitable substances may come in direct contact with electronic rescue apparatus such that company policies are being implemented wherein such apparatus must be intrinsically-safe or incapable of being a source of ignition. Other safety concerns encompass critical pathway issues wherein doors must be held securely open to prevent inadvertent locking of the door thereby trapping rescuers and wherein a safe egress must be established for the transport of tools, medical supplies, water hoses and other apparatus and ultimately for the safe evacuation of persons and rescuers. Tertiary needs for holding doors in fixed positions may include the vacating of smoke or other toxic gases. Another significant safety issue concerns heat-exhaustion and fatigue of rescuers which is compounded when building structures comprise many rooms, chambers, doorways and stairways that must be climbed and traversed by rescuers encumbered with burdensome and heavy, protective clothing, breathing apparatus, water hoses and a plethora of tools, medical supplies, and other equipment such that the combined weight, coupled with high building temperatures and individual body-heat, becomes a significant fatigue factor. It becomes critically important for rescuers to have at their disposal, tools and other apparatus that are small, light-weight, compact, easily-transportable and easily-manipulateable especially where mobility and manual dexterity are hindered by protective gloves. In an effort to facilitate the holding open of doors and illuminating their doorways, wedges and other uniquely-shaped devices have been designed for sandwiching between a door bottom and a floor to hold the door in a fixed position. One such device is disclosed in U.S. Pat. No. 6,616,128 B2 to Selzer. The Selzer device is capable of sandwiching between a door and its adjacent floor to hold the door securely, however a primary disadvantage of the Selzer device is that it is not low in profile height and otherwise bulky in size and further lacks the capability of ganging a multiplicity of wedges together making the transport of many wedges awkward and difficult whereby a limitation is inherently present as to the number of apparatus that a rescuer may feasibly carry and a limit as to the number of doors that may be secured. Additionally, the Selzer invention relies upon reflective surfaces which pre-supposes that light is present to thereby illuminate the wedge, when in fact, the wedge may become lost in smoke or darkness and cannot serve as a proper egress marker.

Another prior art design which is wedge-shaped and houses a beacon is disclosed in U.S. Pat. No. 5,109,322 to Loughlin. The Loughlin device could serve as a an egress marker in that it houses a beacon which is a strobe light, however, as a door holding device it cannot likely be wedged underneath a door bottom as the ramped portion of its design is steep and not acutely angled and further relies on impact driven tools to mechanically secure itself to an adjacent building structure such as being nailed onto a door frame. Furthermore, the Loughlin device is tall in profile and has no means to gang a multiplicity of similar devices together. Another disadvantage of the Loughlin design is that, although it utilizes a beacon for illumination of a doorway, it does not disclose the ability to illuminate in a wide variety of colors and patterns of colors and further discloses that the invention is heat, chemical, water and impact resistant but does not disclose that the entirety of its electronic components are sealed and impervious to such substances whereby the Loughlin invention could be penetrated by potentially flammable substances and thereby short out creating a possible a source of ignition. Similarly, the very act of striking its pin or spike could cause a spark and thereby be a dangerous source of ignition. The Loughlin device does not disclose any means to lengthen battery life therefore it is likely that the Loughlin device could not power a strobe with a nine volt battery for any extended length of time whereby the intensity of the strobe is likely to fade rapidly or fail altogether in a short period of time.

Another prior art design which is an emergency lighting device for firefighters is disclosed in U.S. Pat. No. 6,864,799 B2 to Popps. The Popps invention is wedge-shaped and houses a plurality of lamps along with a sounder and could serve to hold a door in a fixed position and could illuminate a doorway. A primary disadvantage of the Popps design is that it is relatively large in size whereby it is not likely that even one such device could easily fit within the confines of a utility pocket, furthermore, the Popps device does not disclose any means to gang-together a multiplicity of similar devices and surely would constitute a large, bulky and cumbersome mass should a rescuer attempt to stack many such devices atop one another. The Popps invention does not disclose a built-in means to increase its overall height and does not disclose that the device is intrinsically-safe or incapable of being a source of ignition whereby its exposed switch and open ports of its sounder could be a pathway for flammable or ignitable substances to enter and cause ignition. The Popps invention is further limited to red or green laser diodes as illumination devices.

Another prior art design is disclosed in U.S. Pat. No. 6,317,047 B1 to Stein et al. The Stein invention discloses a firefighter's safety device for holding open a door which further comprises a sounder, a light source and a heat sensor, however, the Stein invention is not wedge-shaped and is specifically designed to hang about a door hinge. A primary disadvantage of the Stein invention is that a door may utilize a contiguous piano hinge whereby there is no access point to which the invention may be attached, furthermore, the invention may not securely hold the door in a fixed position whereby a falling object or person impacting the door may cause it to swing abruptly, popping out the device and allowing the door to swing about causing possible bodily injury or inadvertently allowing the door to lock closed. The device discloses no colored lamps or patterns of colors being an object, it is not stackable or ganged one to another and due to its cylindrical shape, is not suitable for sandwiching beneath a door bottom and an adjacent floor. The device does not disclose that it is in any way sealed, such that its electronic circuitry housed therein could conceivably be a source of ignition should flammable substances come in contact with its electronics.

Another prior art design is disclosed in U.S. Pat. No. 4,501,444 to Dominguez. The Dominguez invention discloses a collapsible device that does house a pivoting member as a means to increase its overall height and thereby also creating a wedge-shaped apparatus for holding open a door. A primary disadvantage of the Dominguez invention is that is does not provide an acutely-angled edge suitable for tighter fitting doors, it does not house any means of signaling nor by lamps nor reflective attachments. Furthermore, the Dominguez design is inherently dangerous as the opposing planar members form a scissor-like cutting tool which could literally sever the fingers of a user attempting to deploy the device wherein an abrupt impacting of the door may compress the scissor-like planes and severely injure the user. Additionally, the Dominguez design is constructed of several individual pieces that must be assembled and discloses no means to gang one to another. Also, if the invention were made of metal parts as supposed, its use would not be safe in and around flammable materials as forces acting upon the door could cause the device to slide or skid across a concrete surface and thereby generate sparks thereby becoming a source of ignition.

An improved door-holding device or ramp is thus needed that is specifically designed to overcome the disadvantages herein reviewed. An improved ramp is needed that is low-profile in design bearing a frontal edge that is acutely-angled such that it may accommodate tighter fitting doors possibly outfitted with smoke seals. An improved ramp is needed that bears a means to gang a multiplicity of identical ramps to each other so as to form a compact, singular block of ramps that may easily fit within the confines of a utility pocket and be sufficiently small and lightweight such that carrying and transporting a substantial quantity of ramps is easily performed without significantly adding to the overall fatigue of a rescuer outfitted with the ramps. An improved ramp is needed that is intrinsically-safe and incapable of being a source of ignition thereby being safe to deploy in environments in which the ramps may come in direct contact with flammable or explosive substances and where surrounding air may be contaminated with ignitable gases. An improved ramp is needed that is intrinsically-safe wherein all of its electronic components are sealed within a transparent and replaceable module that is impervious to penetration by such gases, liquids and other ignitable substances and where the electronic circuitry is activated and externally-controllable by wireless means and easily operable by a user wearing protective gloves. An improved ramp is needed that contains strategic arrangement of multi-colored lamps capable of illuminating in a wide variety of colors and patterns of colors to visually communicate tactically-significant signals and information to fellow rescuers and other professionals. An improved ramp is needed that bears a means to prolong battery life such that the electronic circuitry and lamps housed therein may persist in actual operation for many hours thereby assuring that the doorway to which the ramp is deployed may remain illuminated and serve as a viable doorway marker and evidence marker for follow-up investigations which could take place dozens of hours later.

An improved ramp bearing all of these improvement features is taught in the following section.

### SUMMARY OF THE INVENTION

It is a principal object of the present invention to provide a multi-functional door-propping ramp for deployment by rescue personnel for the purposes of securing a door in a fixed position and illuminating its doorway with the ramp further being intrinsically-safe such that neither the ramp body nor its electronic components housed therein can cause ignition of potentially-flammable or ignitable substances, and further serving as a multi-purpose visual indicator. It is another object of the present invention to be light-weight and monolithically-constructed of a rigid, transparent and non-metallic material.

It is another object of the present invention to be low-profile in overall height and acutely-angled for accommodation of tightly-fitting under-door gaps such as when a door is outfitted with smoke-seal stripping.

It is an object of the present invention to house at least one rotatable member which is of sufficient size as to be easily operable by a user wearing gloves.

It is an object of the present invention to house at least one rotatable member which, when urged into a semi-perpendicular position, may accommodate taller under-door gaps.

It is an object of the present invention to house at least one rotatable member that rests at predetermined angles and cannot further over-rotate.

It is an object of the present invention to be visually-transparent such that all of its components may be inspected for operational and structural integrity.

It is an object of the present invention to comprise a cavity for receiving an electronic module which is also transparent, disposable and replaceable.

It is an object of the module of the present invention to have no exposed electronic circuitry and that all electronic circuitry is housed within a sealed and intrinsically-safe module.

It is an object of the present invention to provide illumination from a plurality of lamps in a wide variety of colors, patterns and time durations.

It is an object of the present invention to serve as an egress marker, evidence marker and a tactical communications signaling indicator.

It is an object of the present invention to be externally controllable by a wireless interface.

It is an object of the present invention to prolong battery life during non-use.

It is an object of the present invention to provide a means of prolonging battery life such that substantial time durations of actual service are possible.

It is an object of the present invention to reversibly attach one-to-another so as to gang as a contiguous block or cluster for easier handling and transport.

It is an object of the present invention to be economical to produce and thereby expendable if abandoned in place within a building.

It is an object of the present invention to be programmable.

It is an object of the present invention to have no exposed metal parts such that abrasion against hard surfaces, such as concrete, cannot generate sparks or provide a source of ignition.

It is an object of the present invention to be constructed with a minimal number of parts.

It is an object of the present invention to provide a superior door-propping ramp system.

Essentially, the present invention is a low-profile ramp for use by rescue personnel suitable for sandwiching between a door bottom edge and an underlying floor utilizing kinetic friction to thereby hold the door in a fixed position. In a preferred embodiment, the ramp is constructed of a rigid, transparent and non-metallic material wherein the ramp body is incapable of generating sparks if abraded against hard surfaces such as concrete thereby being intrinsically-safe for deployment where potentially-ignitable substance such as flammable liquids or ignitable gases may be present or come in contact with the ramp.

Additionally, the ramp body is constructed with a cavity for receiving an electronic circuit module which is also sealed, transparent and replaceable wherein all of the electronic components are sealed within the module and also deemed intrinsically-safe. The module is transparent so that the structural and functional integrity of the components housed therein may be visually inspected. The module is further held in place or detached by a plurality of detents and small protrusions such that it may snap into place or be easily pried out for replacement as a self contained module.

The main body of the ramp has an acutely-angled frontal edge suitable for disposing under doors that have tightly-fitting gaps such as when a door is outfitted with smoke-seal stripping. An opposing rear edge is raised only minimally so as to maintain a low overall profile which assists in transportability and manipulation by gloved hands.

The ramp main body further comprises at least one rotatable member or rocker-plate which normally lies planar to the ramp body but may pivot about for the purposes of increasing the overall height of the ramp wherein the rocker-plate may be urged into a semi-perpendicular position and comes to rest against built-in stop points or limits created by its unique paddle-shape design, thereby, preventing over-rotation and serving to augment the ramp height such that it now may accommodate doors having a taller under-door gap, additionally, the rocker-plate serves as a kinetic-friction locking mechanism whereby forces acting upon a door, push against the rocker-plate such that it lodges firmly between the door bottom and the underlying floor to hold the door securely in a fixed position thus adding to the versatility of the invention.

Another significant advantage of the ramp of the present invention is its capability of illuminating a plurality of multi-colored and high-brightness lamps that are electronically controlled such that a wide variety of colors, patterns and durations of illumination are programmable and controllable whereby the ramp not only serves as a doorway marker, but may further serve as an intelligent doorway illumination device capable of conveying tactically-significant signals and other information about the status of a room, status of personnel and other determinable rescue signal information. The ramps may also serve as follow-up investigational evidence markers.

Still another multi-functional aspect of the ramp is its capability of stacking or ganging one-to-another by means of symmetrically-positioned detents and protrusions such that each ramp is identical to another and may reversibly attach to form a singular and contiguous block or cluster of ramps similar in fashion to a popular building block toy whereby minimal pressure may allow each individual piece to snugly press-fit together or be easily detached whereby a multiplicity of ramps may easily fit within the confines of a utility pocket and be conveniently transported and operated by a user wearing gloves which otherwise might be a hindrance.

Another added benefit of the block is being able to carry and deploy a significant number of ramps thereby being able to secure a significant number of doors while also minimizing space utilization and minimizing additional burdensome weight.

Further taught by the present invention is an interest in prolonging battery life whereas a relatively small battery must reside with the confines of a fairly small module, the battery size is an important factor regarding current capacity wherein circuitry has been configured to send out pulse-bursts to the lamps whereby the lamps are duty-cycled such that current is being drawn only percentages of time rather than a more debilitating constant current draw thereby assisting to prolong battery life such that the ramp may be left in place with its lamps operational for extended periods of time which is likely to be dozens of hours whereby next day follow-up investigations should find the lamps still operational. On-board circuitry is also designed to go into a sleep mode during non-use or a quiescent state which draws absolute minimum currents thus further assisting to prolong battery life.

A special feature of the ramp relates to its wireless means of activating and controlling the electronic circuit module wherein a small magnet located in a proximal end of the rocker-plate interfaces wirelessly with a magnetically-operable switch housed within the adjacently-lying circuit module whereby all portions of the electronics are sealed having no external switches or wires wherein each rotation in and out of proximity of the rocker-plate from the switch causes the switch to engage and disengage whereby each subsequent switching action causes the circuitry to wake up and advance by one sequence thereby being wirelessly-controllable and programmable. Sequences may include a wide variety of color illuminations, patterns of colors and a wide variety of time durations applied to each lamp greatly adding to its versatility and communications options. The module comprises a small battery, electronic circuit, printed circuit medium, a plurality of lamps and a magnetically-operable switch.

### BRIEF DESCRIPTION OF THE DRAWINGS

FIG. 1 is a perspective view of the ramp of the invention showing the major structures.

FIG. 2 is a perspective view of the ramp of the invention with greater detail as to other structures.

FIG. 3 is a perspective view of the ramp of the invention in a collapsed state and being sandwiched to fill a short gap between a door bottom edge and its underlying floor.

FIG. 4 is a perspective view of the ramp of the invention with a rotatable member being urged into a semi-perpendicular state and being sandwiched to fill a taller gap between a door bottom edge and its underlying floor.

FIG. 5 is an enlarged and partially-exploded perspective view of an electronic module separated from a cavity within the ramp body.

FIG. 6 is a side view of a plurality of identical ramps being ganged together and illustrated within a typical utility pocket.

### DETAILED DESCRIPTION OF THE PREFERRED EMBODIMENT

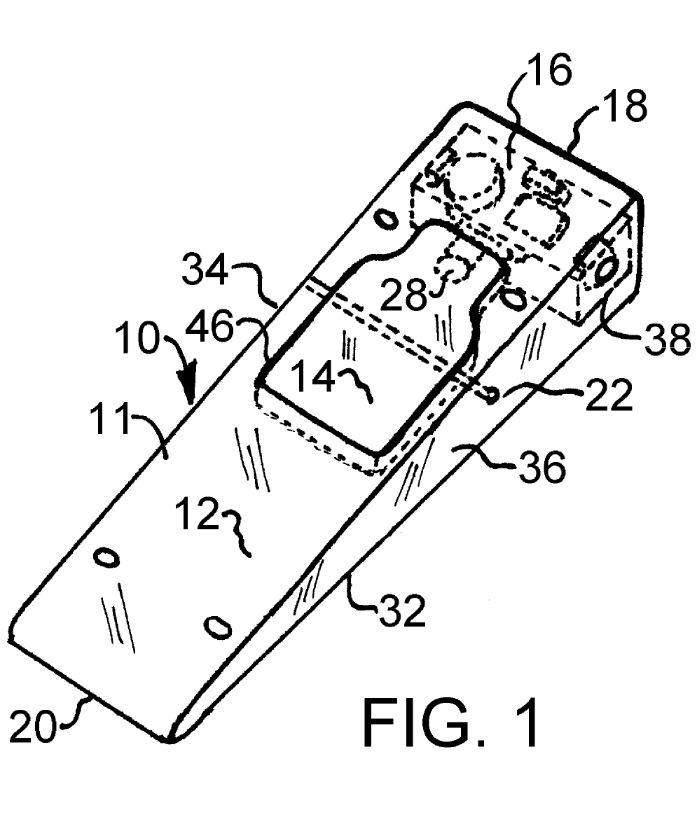

Referring to the drawings, the ramp of the present invention is generally designated by the numeral 10. As shown in FIG. 1, the ramp 10 is in its normal, collapsed state and bears the major structures of a main ramp body 11 having a planar and textured lower portion 32 with an opposing, inclined and textured upper portion 12. An acutely-angled front edge 20 is opposed by a slightly taller rear edge 18 and supported by integral and monolithically-composed sidewalls 34 and 36 respectively whereby a low-profile ramp is fashioned thereof. Additionally, the ramp body 11 bears a rotatable member 14 which lies within a through opening 46 and is attached with a sturdy metal dowel pin 22 passing therethrough which partially embeds into sidewalls 34 and 36. A magnet 28 is disposed at an edge of the rotatable member 14 which lies in proximity to an electronic module 16 and more specifically to a magnetically-operable switch 44 housed within module 16 wherein a wireless control interface is formed thereby.

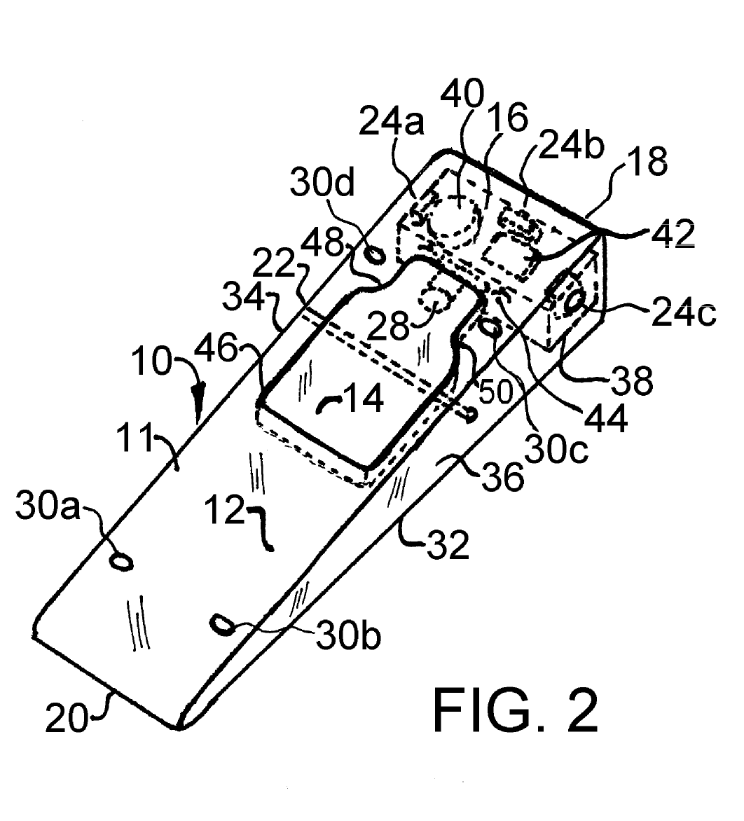

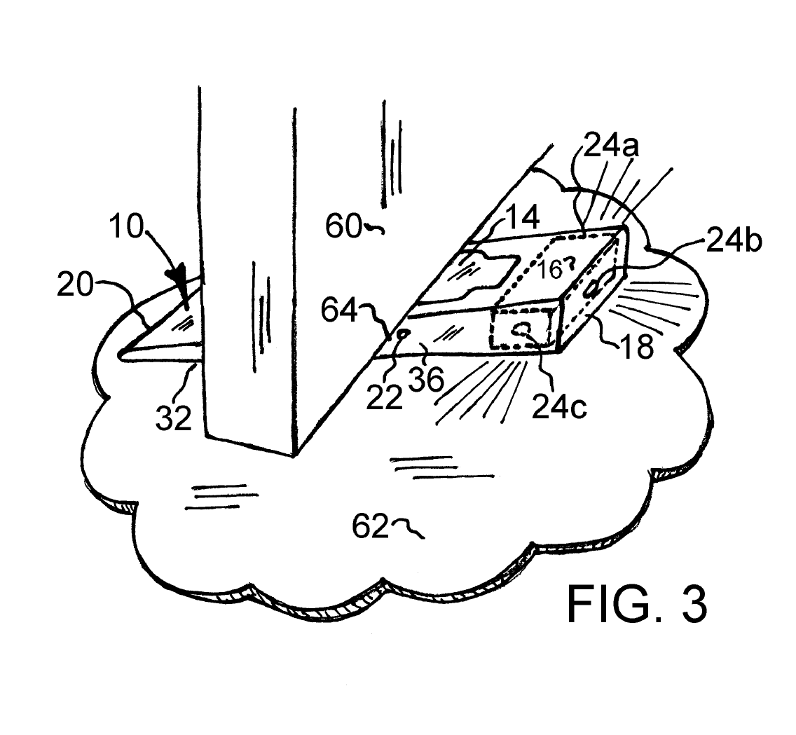

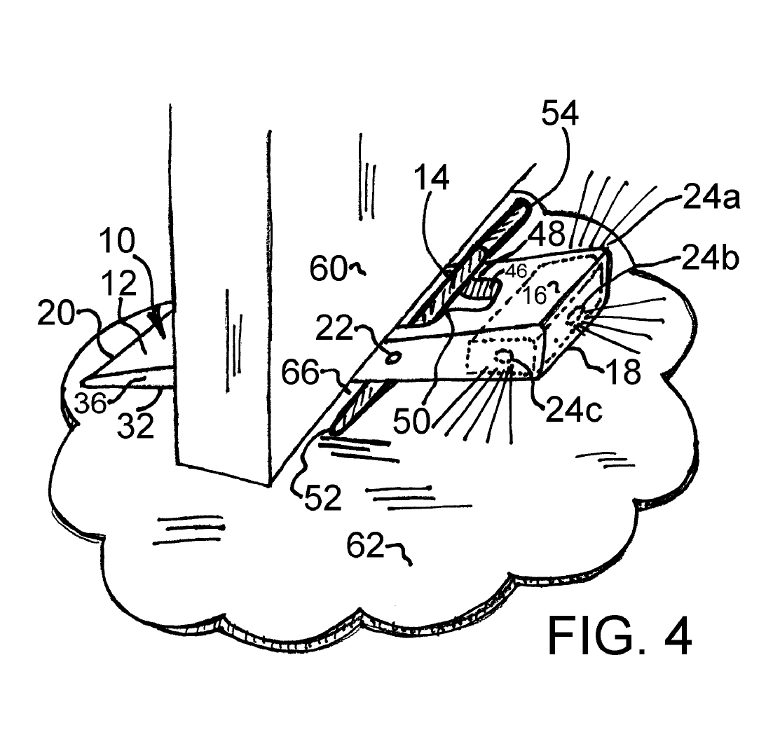

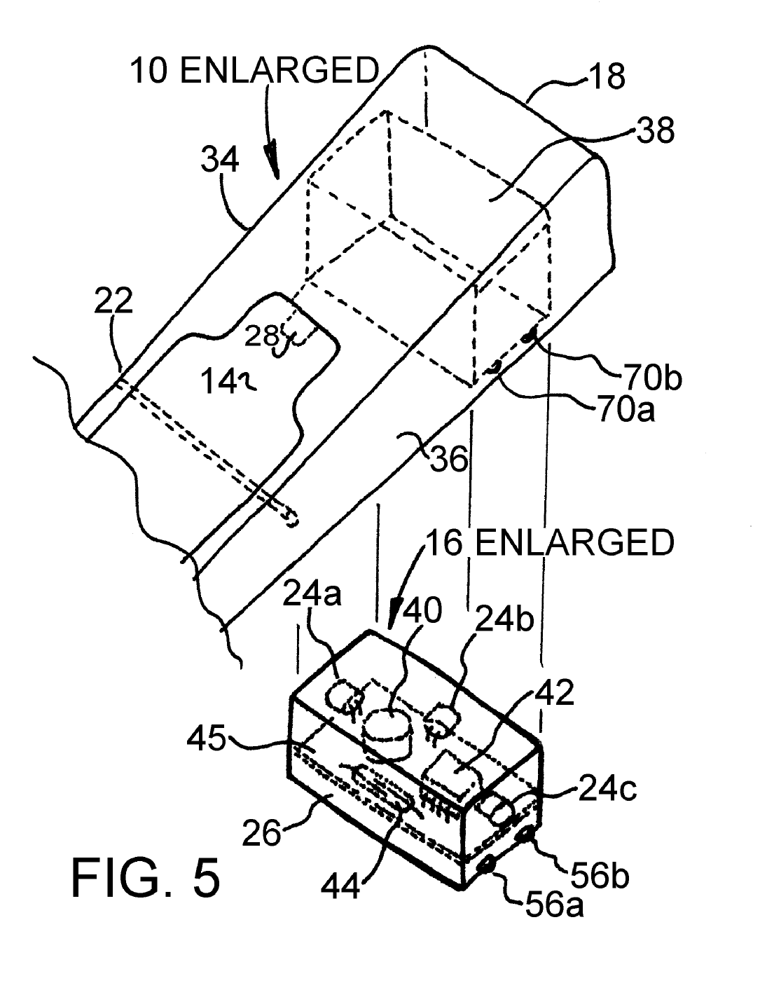

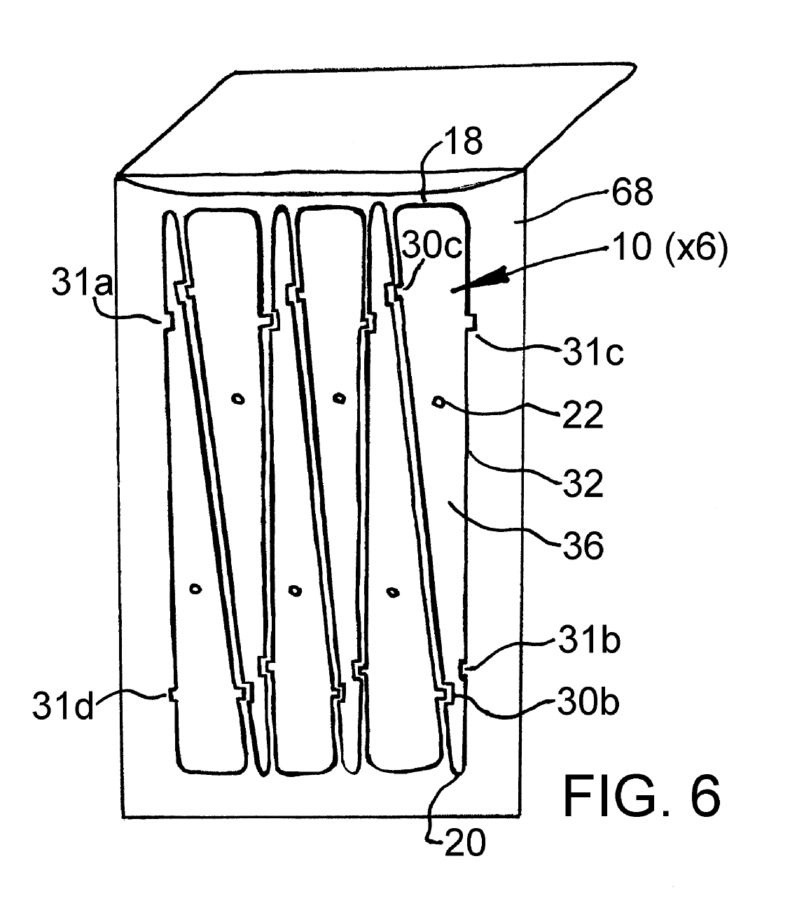

Referring specifically to FIG. 2, the ramp 10 further bears a rotatable member, paddle, lever or rocker-plate 14 which is paddle-shaped and sufficiently large for a user wearing gloves to manipulate and is pivotally-attached within a paddle-shaped through opening 46 which also bears rotation-limiting stops, rests or limits 48 and 50 respectively. Attachment points 30a, 30b, 30c, and 30d lie symmetrically-aligned on surface 12 which are utilized to gang a multiplicity of ramps together. As shown in FIG. 3, the ramp 10 is deployed or sandwiched with rocker-plate 14 in a planar state between a door 60 and its underlying floor 62 filling a short gap 64 therebetween to hold door 60 in a fixed position. Module 16 bears a plurality of lamps 24a, 24b and 24c which are illuminated. Referring specifically to FIG. 4, the ramp 10 is deployed or sandwiched with rocker-plate 14 in a semi-perpendicular state and resting upon stop points or limits 48 and 50 with edge 52 now resting upon floor 62 and edge 54 in a semi-vertical state. A taller under-door gap 66 is thus accommodated and door 60 is thereby held in a fixed position. Lamps 24a, 24b and 24c are illuminated. FIG. 5 illustrates ramp 10 and module 16 enlarged and exploded. Module 16 is removable and held in place by protrusions or posts 56a and 56b which snap into detents or receptacles 70a and 70b. Module 16 has a transparent and sealed casing 26 which is impenetrable by gases or liquids, a printed circuit medium 45, the magnetically-operable switch 44, the plurality of lamps 24a, 24b and 24c, a battery 40 and an electronic circuit or circuitry 42. Casing 26 and sidewalls 34 and 36 as well as rear edge 18 are clear and transparent plastic such that light from the lamps 24a, 24b and 24c shine through the casing 26, sidewalls 34 and 36 and rear edge 16 thereby obviating any unwanted penetrations and thus maintaining isolation from liquids and gases. Additionally, casing 26 and the entirety of ramp body 11 are made of clear and transparent plastic which when abraded against other surfaces does not generate sparks. Referring specifically to FIG. 6, a plurality of ramps 10 are shown ganged together to form a contiguous and singular block comprised of six individual ramps 10. The lower portion 32 bears symmetrically-aligned attachment points 31a, 31b, 31c and 31d which are sized to interfere slightly such that a snug fit between mating parts holds them together. A typical vest pocket 68 is shown with the block of ramps 10 comfortably fitted within pocket 68 for convenient transportability.

Accordingly, there has been provided, in accordance with the invention, an intrinsically-safe ramp for use by rescue personnel for holding a door in a fixed position and illuminating its doorway. It is to be understood that all terms used herein are descriptive rather that limiting. Although the invention has been described in conjunction with the specific embodiment set forth above, many alternative embodiments, modifications and variations will be apparent to those skilled in the art in light of the disclosure set forth herein. Accordingly, it is intended to include all such alternatives, embodiments, modifications and variations that fall within the spirit and scope of the invention as set forth in the claims herein included.

What is claimed is:

1. An intrinsically-safe ramp for propping a door in a fixed position and illuminating its doorway, comprising:
a solid main ramp body having opposing upper and lower planar portions and a thin frontal edge where said portions adjoin and where said upper portion gradually inclines upwardly away from said lower portion to adjoin a slightly taller opposing rear edge whereby a solid, low-profile ramp having integral sidewalls is formed thereof, the ramp body further comprising;
ganging means to fasten one ramp to another identical ramp,
at least one cavity for retaining a disposable electronic module therein, at least one electronic module retainable within said cavity and lying adjacent to a rotatable member,
at least one through opening for receiving the rotatable member,
at least one rotatable member pivotally-mounted within said opening,
said rotatable member comprising;
a paddle-shaped, rocker-plate having a metal dowel pin passing therethrough being partially embedded into said sidewalls and further having at least one magnet housed within an edge proximal to said electronic module,
said rocker-plate further providing;
height augmentation means to increase overall ramp height,
pivot means to rotate into a semi-perpendicular position at a predetermined angle,
stop means to prevent over-rotation,
locking means to stabilize the ramp position and utilize kinetic friction,
wireless interface control means for communicating with and externally controlling said electronic module,
said electronic module comprising;
a casing being of a material which is sealed, durable, transparent and impervious to and impenetrable by potentially-flammable or ignitable substances,
said electronic module further comprising;
a printed circuit medium housed and sealed within said casing,
at least one battery affixed to said medium,
an electronic circuit affixed to said medium,
a plurality of lamps affixed to said medium,
a magnetically-operable switch affixed to said medium,
said electronic module further providing;
operations means to illuminate said lamps in a variety of colors, patterns and durations of illumination,
first battery-life prolonging means during non-use or quiescent states,
second battery-life prolonging means during actual service,
visual inspection means to verify structural and functional integrity of the electronic circuitry housed therein,
wireless control means whereby any physical penetrations for interfacing with said electronic circuitry are obviated,
replaceable means whereby said module is removable and replaceable,
accessibility means whereby a user wearing gloves may easily operate and control said circuitry housed within said module.

2. The ramp of claim 1 wherein said main ramp body further comprises; a solid, rigid, transparent and monolithically-constructed body comprising materials selected from the group consisting of heat-tolerant and impact-tolerant and chemical-tolerant plastics whereby said ramp body is see-through, impenetrable by and impervious to liquids and gases, is uniformly solid, being of the same material throughout, and constructed of propitiously benign material which is incapable of generating sparks if abraded against other materials or hard surfaces and chemically-neutral whereby said ramp body is intrinsically-safe for use in and around potentially-flammable or ignitable substances.

3. The ramp of claim 1 wherein said ramp body further encloses said metal dowel pin within the confines of said ramp body wherein said metal dowel pin is encapsulated and protected from possible abrasion wherein sparks cannot be generated whereby said ramp body is intrinsically-safe for use in and around potentially-flammable or ignitable substances.

4. The ramp of claim 1 wherein said upper and lower planar portions have exposed surfaces that are randomly textured whereby the texturing of said surfaces affords frictional resistance against unwanted slipping or sliding of said ramp when sandwiched between a door bottom edge and its underlying floor.

5. The ramp of claim 1 wherein said accessibility means to operate and control said circuitry housed within said module is provided by the strategic location of said rocker-plate being centrally positioned and having a surface area which is sufficiently large whereby a user wearing gloves may operate and control said circuitry.

6. The ramp of claim 1 wherein said replacing means is provided by said module being a removable and self-contained entity which bears minute protrusions on its exterior which engage corresponding minute recesses or detents within said cavity whereby the module may be snapped into said cavity or similarly removed therefrom.

7. The ramp of claim 1 wherein said wireless control means is provided by the magnetically-operable switch being engaged and disengaged solely by forces of magnetism exuded from the adjacently lying magnet housed within the rocker-plate and as said rocker-plate is moved in and out of proximity with said switch whereby a wireless control is established.

8. The ramp of claim 1 wherein said visual inspection means is provided by the casing structure of said module being transparent or see-through and removable whereby close visual inspection of components housed therein may be conducted to verify functional and structural integrity.

9. The module of claim 1 wherein the second battery-life prolonging means during actual service is provided by pulse-burst circuitry housed within said module delivering interrupted or duty-cycled current to said plurality of lamps whereby the battery is required to deliver only percentages of current draw which is far less debilitating than constant current draw whereby battery life is prolonged during actual service.

10. The module of claim 1 wherein the first battery-life prolonging means during non-use or quiescent states is provided by detection circuitry housed within said module which senses that no lamps are being illuminated and thereby goes into sleep mode or standby mode which sips or uses absolute minimum current draw whereby battery life during non-use is prolonged.

11. The module of claim 1 wherein the operations means to illuminate said lamps in a variety of colors, patterns and duration of illumination is provided by sequence circuitry housed within said module being selected from the group consisting of micro-processors and micro-controllers and other logic gates whereby predetermined operations options are selectable being advanced in sequential stages with each subsequent switch engagement.

12. The module of claim 1 wherein said plurality of lamps are selected from the group consisting of high-brightness and long-life and multi-colored light-emitting-diodes whereby said lamps are highly-visible, long-lasting and capable of illuminating in a variety of color options.

13. The module of claim 1 wherein said casing is of a material which is durable, transparent and impervious to and impenetrable by potentially-flammable or ignitable substances is further comprised of material selected from the group consisting of heat-tolerant and impact-tolerant and chemical-tolerant plastics whereby said casing is see-through, durable and constructed of propitiously benign material which is chemically-neutral and suitable for use in and around potentially-flammable or ignitable substances.

14. The rocker-plate of claim 1 wherein said wireless interface control means is provided by the magnet housed within said rocker-plate and wherein the forces of magnetism exuded thereof act upon the adjacently-lying magnetically-operable switch whereby a user may move said rocker-plate in and out of proximity with said switch causing said switch to engage and disengage whereby a wireless interface control is established.

15. The rocker-plate of claim 1 wherein said locking means to stabilize the ramp position and utilize kinetic friction is provided by said rocker-plate being urged into a semi-perpendicular state and locking against built-in stops whereby said rocker-plate affords additional kinetic friction and stabilization when sandwiched between a door bottom edge and its underlying floor.

16. The rocker-plate of claim 1 wherein said stop means to prevent over-rotation is provided by indentations within said through opening interfering with a wider portion of said rocker-plate after being urged into a semi-perpendicular state whereby the unique paddle-shaped design creates interference points such that over-rotation is obviated.

17. The rocker-plate of claim 1 wherein said pivot means to rotate into a semi-perpendicular position at a predetermined angle is provided by a metal dowel pin passing laterally through a position slightly off-center of the mid-line of said rocker-plate and where wider portions of said rocker-plate lock against indentations within said through-opening which is set back such that an optimal and predetermined angle is achieved thereby.

18. The rocker-plate of claim 1 wherein said height augmentation means is provided by said rocker-plate after being urged into a semi-perpendicular wherein a portion of said rocker-plate protrudes below the lower planar portion effectively adding height to the ramp when sandwiched between a door bottom edge and its underlying floor whereby said ramp may accommodate doors having taller under-door gaps.

19. The ramp of claim 1 wherein said ganging means to fasten one ramp to another identical ramp is provided by a plurality of symmetrically-aligned protrusions or posts and a plurality of detents or receptacles positioned about the ramp body and which are interferingly dissimilar in size such that minimal manual pressure may cause said posts and receptacles to snugly fit together whereby a gang or multiplicity of ramps may be fashioned into a singular and contiguous block of ramps for easier transportability.

20. The ramp of claim 1 wherein said main ramp body having a thin frontal edge which suitable for sandwiching between a door bottom edge which is closely positioned to its underlying floor whereby a thinner edge may accommodate doors with shorter gaps such as door outfitted with smoke-seal stripping.
